(19) United States
(12) Patent Application Publication
(10) Pub. No.: US 2006/0088093 A1
(43) Pub. Date: Apr. 27, 2006

(54) Packet loss compensation

(75) Inventors: Ari Lakaniemi, Helsinki (FI); Pasi Ojala, Kauniainen (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/028,580

(22) Filed: Jan. 5, 2005

(30) Foreign Application Priority Data
Oct. 26, 2004 (EP) 04 025 387.4

(51) Int. Cl. H04N 11/04; H04N 11/02; H04N 7/12; H04B 1/66

(52) U.S. Cl. 375/240.01

(57) ABSTRACT

The invention relates to enabling a compensation of packet losses in a packet based transmission of data frames, wherein packets provided for transmission include a first type of frames corresponding to a respective data frame encoded using a first bit rate coding mode and a second type of frames corresponding to a respective data frame encoded using a second bit rate coding mode. In order to limit the processing power in the packet generation, parameters are extracted from a data frame which is to be transmitted in accordance with the first bit rate coding mode. The extracted parameters are quantized in accordance with the first bit rate coding mode to obtain quantized parameters forming a frame of the first type. In addition, a frame of the second type is generated based on the parameters extracted for the frame of the first type and/or on the quantized parameters of the frame of the first type.

### FIELD OF THE INVENTION

The invention relates to a method for enabling a compensation of packet losses in a packet based transmission of data frames, wherein packets provided for transmission include a first type of frames corresponding to a respective data frame encoded using a first bit rate coding mode and a second type of frames corresponding to a respective data frame encoded using a second bit rate coding mode. The invention relates equally to a corresponding encoder, to an electronic device comprising such an encoder, and to a packet based transmission system comprising such an encoder. The invention relates further to a corresponding software code and a software program product storing such a software code.

### BACKGROUND OF THE INVENTION

A packet based transmission system comprises an encoder at a transmitting end, a decoder at a receiving end and a packet switched transmission network, for instance an Internet Protocol (IP) based network, connecting both. Data which is to be transmitted is encoded by the encoder and distributed to packets. The packets are then transmitted independently from each other via the packet switched transmission network to the decoder. The decoder extracts the data from the packets again and reverses the encoding process.

A well-known codec which is employed for packet based transmissions of speech is the Adaptive Multi-Rate (AMR) speech codec, which is an algebraic code excitation linear prediction type of codec. The operation of the AMR codec is based on relatively strong dependencies between successive frames of a data stream and synchronized encoder and decoder states. An efficient compression is reached by encoding/decoding each frame relative to a current encoder/decoder state, each processed frame updating the encoder/decoder state accordingly. For details of the AMR encoding and decoding, it is referred to the 3GPP document TS 26.090 V5.0.0 (2002-06): “Technical Specification Group Services and System Aspects; Mandatory Speech Codec speech processing functions; Adaptive Multi-Rate (AMR) speech codec; Transcoding functions”, (Release 5), which is incorporated by reference herein.

Even in a healthy operating environment, some of the packets transmitted via a packets switched network will usually be lost.

Packet losses in IP networks are a major hurdle for a conversational speech service. In case of a packet loss, the decoder does not receive any information at all, and it has to reproduce the speech frame included in the lost packet based exclusively on the information from previous and following frames. Therefore, the decoder has to employ a completely different error concealment approach compared to the error concealment approach employed for transmissions via a circuit switched system, like GSM, in which an erroneous bit stream still contains some usable information bits.

In case a speech frame is lost in transmission, the decoder thus invokes an error concealment algorithm, which tries to extrapolate and/or interpolate missing piece of a signal based on preceding and/or following frames, and at the same time it also tries to update the decoder state accordingly. Nevertheless, each missing frame will not only degrade the speech quality during the frame that has been compensated by the error concealment algorithm, but the quality degradation also propagates to a few frames following immediately after the lost frame due to the mismatch between encoder and decoder states, which cannot be compensated exactly with the update.

A particular solution for error concealment in case of packet losses in IP networks is to utilize a forward error correction (FEC) by adding redundancy to the bit stream. In the simplest configuration, a direct repetition of a respective previous frame of a data stream is transmitted together with each respective new frame. The new frame forms a primary frame, and the previous frame forms a redundant frames in a respective packet. This is a very lightweight approach in terms of processing load, since the redundant frame is readily available and no additional processing is required. However, since typically the application uses the highest possible bit rate for the primary data stream of speech frames to maximize the speech quality, a direct repetition of frames might lead to an unfeasibly high total bit rate. To optimize the overall quality and transmission capacity, the redundant information containing the encoded speech from the previous frame can be included instead with a significantly lower bit rate.

Now, in case of a packet loss, the decoder waits for the next packet containing redundant information that can be applied to reconstruct the missing information in the previous packet. It has to be noted that the decoder side does not necessarily have to be aware of the redundant transmission. If there are no packet losses, the receiver just gets two copies of the same frame, where a frame can be recognized as a duplicate by its timestamp, and naturally discards the second one—typically the redundant one arriving later and/or encoded with a lower bit rate.

Transmission of redundant frames together with the primary data thus provides a mechanism to boost the speech quality in case of excessive packet loss with cost of a small additional delay. This naturally gives a clear quality improvement, since a frame can be decoded based on real data instead of using error concealment.

The AMR Real Time Protocol (RTP) payload format and the AMR RTP decoder support FEC using a repetition of a previous frame at the same bit rate or at a lower bit rate without any modifications. Conventionally, the primary data stream and the redundant data stream are processed for the FEC with different AMR modes using separate encoder instances, as depicted in FIG. 1.

FIG. 1 is a schematic block diagram of a conventional AMR based speech encoder providing a redundant data stream.

The speech encoder comprises a first AMR encoding component 12 for the primary data stream, which is connected directly to a packet assembler 15. The transmitter further comprises a second AMR encoding component 13 for a redundant data stream, which is connected via a buffer 14 to the packet assembler 15.

The first AMR encoding component 12 receives speech frames and performs an encoding using a higher bit rate AMR mode, resulting for example in a bit rate of 7.4 kbit/s. The encoded data for a respective primary frame is provided to the packet assembler 15. In parallel, the second AMR encoding component 13 receives the same speech frames and performs an encoding using a lower bit rate AMR mode, resulting for example in a bit rate of 4.75 kbit/s. The encoded data for a respective redundant frame is provided first to the buffer 14. The buffer 14 buffers the redundant frame for the duration of one frame and forwards it only then to the packet assembler 15.

The packet assembler 15 assembles a respective RTP packet for transmission by combining an RTP header with an old redundant frame obtained from the buffer 14 and a new primary frame obtained from the first AMR encoding component 12.

With the encoder of FIG. 1, a total bit rate of approximately 12.2 kbit/s can be reached for example by using the 7.4 kbit/s AMR mode for the primary encoding, and adding the redundant information using the 4.75 kbit/s AMR mode. Although in an error-free case, the quality of the primary data stream is then lower than that of a primary data stream generated using the 12.2 kbit/s AMR mode, in packet error conditions the overall quality is significantly better due to the ability to recover from single packet losses completely. Still, the bandwidth required for the redundant data stream is reduced compared to the primary data stream.

While the approach presented with reference to FIG. 1 thus enables a significantly better usage of transmission bandwidth than a simple repetition of the primary frames, it also has drawbacks.

Running two encoding components at the same time for encoding each input speech frame at two different rates also roughly doubles the required processing capacity. The resulting processing load might even be too high for some platforms, in particular in capacity-limited devices like low-end mobile terminals.

Another problem is a mismatch between encoder and decoder states in case a frame of the redundant data stream is used to replace a lost frame of the primary data stream, which can lead to speech quality degradation. Due to state-machine kind of operating principle of the AMR codec, the approach presented with reference to FIG. 1 generates a mismatch between the encoder state in AMR encoding component 12 used for encoding a frame of the primary stream and the encoder state in AMR encoding component 13 used for encoding the corresponding frame of the redundant stream. This mismatch will become apparent at the decoder in case of a required packet loss compensation. This affects especially those parameter values that are predicted based on values which are computed or received for the previous frame.

### SUMMARY OF THE INVENTION

It is an object of the invention to enable a generation of redundant data with little processing power for a packet based data transmission.

A method for enabling a compensation of packet losses in a packet based transmission of data frames is proposed, wherein packets provided for transmission include a first type of frames corresponding to a respective data frame encoded using a first bit rate coding mode and a second type of frames corresponding to a respective data frame encoded using a second bit rate coding mode. The method comprises extracting parameters from a data frame which is to be transmitted in accordance with the first bit rate coding mode. The method further comprises quantizing the extracted parameters in accordance with the first bit rate coding mode to obtain quantized parameters forming a frame of the first type. The method further comprises generating a frame of the second type based on at least one of the parameters extracted for the frame of the first type and the quantized parameters of the frame of the first type.

Moreover, an encoder for encoding data frames for a packet based transmission is proposed, which encoding enables a compensation of packet losses in a transmission. Packets provided for transmission include a first type of frames corresponding to a respective data frame encoded using a first bit rate coding mode and a second type of frames corresponding to a respective data frame encoded using a second bit rate coding mode. The encoder comprises an encoding portion, which is adapted to extract parameters from a data frame which is to be transmitted in accordance with the first bit rate coding mode. The encoding portion is further adapted to quantize extracted parameters in accordance with the first bit rate coding mode to obtain quantized parameters forming a frame of the first type. The encoding portion is further adapted to generate a frame of the second type based on at least one of parameters extracted for a frame of the first type and quantized parameters of a frame of the first type.

Moreover, an electronic device is proposed, which comprises the proposed encoder.

Moreover, a packet based transmission system is proposed. The system comprises the proposed encoder, a decoder adapted to decode data encoded by the encoder, and a packet based transmission network adapted to enable a packet based transmission of encoded data between the encoder and the decoder.

Moreover, a software code for enabling a compensation of packet losses in a packet based transmission of data frames is proposed, wherein packets provided for transmission include a first type of frames corresponding to a respective data frame encoded using a first bit rate coding mode and a second type of frames corresponding to a respective data frame encoded using a second bit rate coding mode. When running in a processing component of an electronic device, the software code realizing the steps of the proposed method.

Finally, a software program product is proposed, in which the proposed software code is stored.

The first type of frame can be for example a primary frame corresponding to a respective current data frame, which is encoded using a higher bit rate coding mode, and the second type of frame can be for example a redundant frame corresponding to a respective previous data frame, which is encoded using a lower bit rate coding mode. For this case, the encoder may further comprise a buffer adapted to buffer generated frames of the second type, and a packet assembler adapted to assemble in a respective packet a packet header, a frame of the first type provided by the encoding portion for a current data frame and a frame of the second type provided by the buffer for a preceding data frame. It is to be understood that the expression ‘previous data frame’ does not refer necessarily to the data frame immediately preceding the current data frame; a previous data frame may also have a larger distance to the current data frame. Further, it is to be understood that a redundant frame provided for a respective primary frame may be transmitted more than once in various packets. Thus, each packet may comprise redundant frames for a plurality of primary frames. This enables a compensation even if several consecutive packets are lost.

The invention proceeds from the consideration that the coding modes used by an encoder for generating data streams of different bit rates are usually very similar to each other. The parameters the encoder extracts may actually be more or less the same over all coding modes—in the higher bit rate modes they are just computed and quantized using a greater granularity to ensure a better data quality over a wider variety of different input signals. It is therefore proposed that the parameters extracted for generating a first type of frames for transmission are used in addition, either directly or indirectly, as well for generating a second type of frames for transmission. The extracted parameters may be quantized to obtain the frames of the first type and be used at least partly in addition to obtain the frames of the second type. Alternatively, the extracted parameters may first be quantized to obtain frames of the first type, and the quantized parameters of the frames of the first type may then be used as a basis for obtaining frames of the second type.

It is an advantage of the invention that it provides a computationally very efficient way to generate two data streams encoded with different bit rates. The encoded data streams can be employed, for example, for a bandwidth-efficient redundant transmission using a high-rate coding mode for a primary data stream, and a low-rate coding mode for a redundant data stream.

As the parameters have to be extracted only once for both bit rates, the complexity of the encoding is reduced. At the same time, a state mismatch at encoder and decoder is automatically avoided as well, since a frame of the second type is always based on the parameters extracted for a frame of the first type and thus on the same encoder state as used for obtaining a frame of the first type.

In particular if the frames of the second type are used as redundant frames, they do not necessarily have to perfectly match the encoding process for the original second rate coding mode. Since the redundant data is used only to add redundancy to the transmitted data stream, it will only be used for an error concealment in case of a packet loss. With packet losses well below 10% of all transmitted frames in any healthy operating environment, minor compromises in the data quality compared to a ‘normal’ encoding can be tolerated and still the resulting quality is far superior to that provided by a traditional error concealment algorithm. For instance, also the AMR codec standards do not require a bit exact operation during error concealment.

It is further an advantage of the invention that the processing can be performed completely on the encoder side. Thus, there is no need to transmit any information about the processing to the decoder or to modify conventional decoders.

In a first approach, a frame of the second type is generated based on the parameters extracted for generating the frame of the first type. Because the parameters are extracted anyway for quantization at the first bit rate, they are also readily available for an additional quantization at a second bit rate. Thus, the extracted parameters can simply be quantized in accordance with the second bit rate coding mode to obtain encoded parameters for the frame of the second type. It is to be understood that not all extracted parameters used in the quantization for a frame of the first type have to be used in the quantization for a frame of the second type. Rather, suitable ones of the extracted parameters may be selected for generating a frame of the second type in accordance with the second bit rate coding mode.

It has already been mentioned above that the resulting frame of the second type does not necessarily have to perfectly match a frame which is encoded using a separate encoding component for the second bit rate coding mode. Such a ‘relaxed’ encoding of the frames of the second type can further streamline the computational burden significantly.

For the first approach, a single, an encoding portion with a single, dual-mode encoding component may be employed. It may be based, for example, on a modified conventional encoder algorithm for the first bit rate coding mode. Instead of encoding only a frame using the first bit rate, as a ‘by-product’ the dual-mode encoding component also outputs a frame at the second bit rate.

In a second approach, a frame of the second type is generated based on the already quantized parameters of a frame of the first type. To this end, In this case, the quantized parameters of the primary frame may be transcoded to obtain quantized parameters of the frame of the second type. Transcoding from a high bit rate coding mode to a low bit rate coding mode is in fact a transformation of parameters from a higher granularity to a lower granularity.

It has already been mentioned above that the resulting frame of the second type does not necessarily have to perfectly match a frame which is encoded using a separate encoding component for the second bit rate coding mode. A perfect match is actually not even possible in the second approach, if the ‘side information’ that is available for the first bit rate coding is not available for the transcoding as well.

For the second approach, a conventional first bit rate mode encoding component can be employed. In addition, a special processing component may be implemented for transcoding the quantized parameters with the first bit rate output by the encoding component to the quantized parameters with the second bit rate to be used for the frame of the second type. The encoding portion thus comprises a single mode encoding component and a transcoder. The second approach provides equally a computationally very efficient way to implement a bandwidth-efficient redundant transmission. At the same time, this approach is also relatively easy to implement or added to an existing data coding system, since it does not require changes to existing encoder or decoder algorithms. In fact, conventional encoder and decoder blocks do not even need to be aware of the additional processing, since an additional processing component can be implemented as an independent block between the encoder and a packetization.

It is to be understood, that alternatively, also in the second approach a conventional encoding component for a first bit rate coding mode could be modified to output frames of the first type and in addition frames of the second type obtained by transcoding.

A transcoding of quantized parameters of a frame of the first type to obtain quantized parameters suited for a frame of the second type can be realized in different ways, which may be selected for example as suited best for the respective parameters. A transcoding may comprise for some parameters, for example, a re-quantization of the quantized parameter. For other parameters, the transcoding may comprise, for example, mapping the quantized parameters of a frame of the first type to quantized parameters suited for a frame of the second type. Such a mapping can be realized for instance by means of a table providing a relation between quantized parameter values of frames of the first type to corresponding quantized parameter values of frames of the second type.

It is to be understood, that both approaches can also be used in a combined manner. That is, some of the quantized parameters for the frame of the second type may be obtained by quantizing the extracted parameters, while other quantized parameters for the frame of the second type may be obtained by transcoding already quantized parameters of the frame of the first type.

Both approaches can be employed for any packet based data transmission supporting different coding modes, in which different bit rates can be achieved based on the same parameters extracted from data frames.

Both approaches can be employed in particular, though not exclusively, for the transmission of speech.

Further, it can use as coding modes for example, though not exclusively, different AMR coding modes, since AMR modes belong to those modes in which only the granularity of the coding parameters is different. In the above cited document TS 26.090, AMR coding modes are defined for 12.2, 10.2, 7.95, 7.4, 6.7, 5.9, 5.15 and 4.75 kbits/s.

In case of an AMR coding, the determined parameters may comprise line spectral frequency parameters, pitch lag values, pitch gains, pulse positions and pulse gains. In case of an AMR coding, the determined parameters may result from a linear prediction coding, from an adaptive codebook coding and from an algebraic codebook coding.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a conventional encoder;

FIG. 2 is a schematic block diagram of a transmission system according to a first embodiment of the invention;

FIG. 3 is a diagram illustrating an operation in the system of FIG. 2;

FIG. 4 is a diagram illustrating a further operation in the system of FIG. 2;

FIG. 5 is a diagram illustrating a further operation in the system of FIG. 2;

FIG. 6 is a schematic block diagram of a transmission system according to a second embodiment of the invention;

FIG. 7 is a diagram illustrating an operation in the system of FIG. 6; and

FIG. 8 is a diagram illustrating a further operation in the system of FIG. 6.

### DETAILED DESCRIPTION OF THE INVENTION

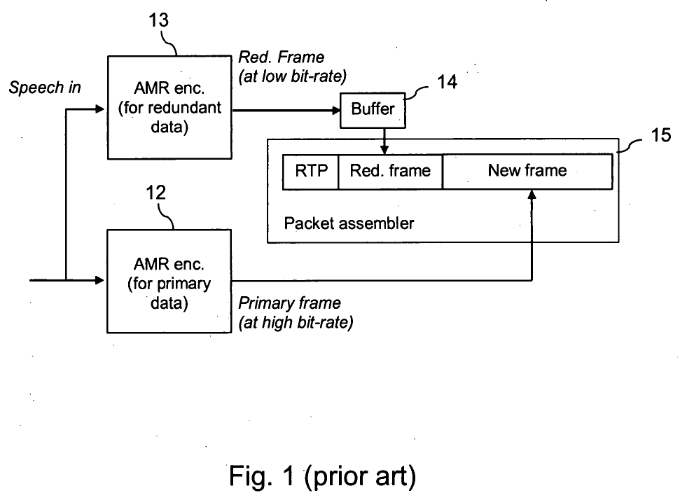

FIG. 1 was already described above. For corresponding components in FIGS. 1 to 8, the same reference signs are used.

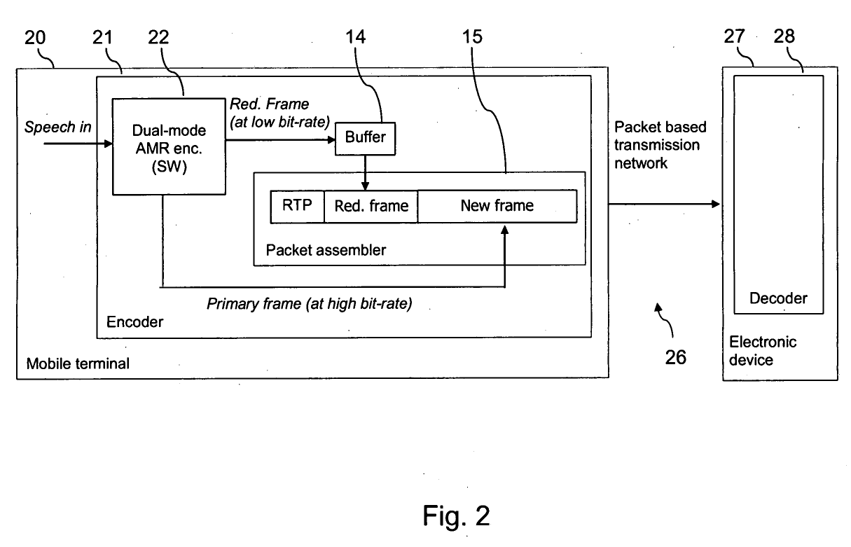

FIG. 2 is a schematic block diagram of a packet based transmission system, which uses an efficient redundancy coding in accordance with a first embodiment of the invention.

The transmission system comprises by way of example a mobile terminal 20, a packet based transmission network 26, like an IP network, and a further electronic device 27.

The mobile terminal 20 is a conventional mobile terminal which comprises an AMR based speech encoder 21 modified in accordance with the invention.

The speech encoder 21 comprises a single AMR encoding component 22. A first output of the AMR encoding component 22 is connected directly to a packet assembler 15. A second output of the AMR encoding component 22 is connected via a buffer 14 to the packet assembler 15.

The other electronic device 27 comprises a conventional AMR base speech decoder 28.

In the AMR encoding component 22, an encoder software code according to an embodiment of the invention is implemented.

The AMR encoding component 22 receives a speech frame and produces from that an encoded primary frame at a selected primary bit rate as known in the art. In addition, as a byproduct, it produces an encoded redundant frame at a selected redundancy bit rate based on the same parameters which are determined for the encoding with the primary bit rate.

The primary frame is provided to the packet assembler 15, and the redundant frame is provided to the buffer 14. The buffer 14 buffers the redundant frame for the duration of one speech frame and forwards it then to the packet assembler 15.

The packet assembler 15 assembles a respective RTP packet in a conventional manner by combining an RTP header with an old redundant frame obtained from the buffer 14 and a new primary frame obtained directly from the AMR encoding component 22.

The assembled RTP packet is then transmitted by the mobile terminal 20 via the packet based transmission network 26 to the other electronic device 27. In the other electronic device 27, the received RTP packets are processed by the AMR based speech decoder 28 in a conventional manner, where the redundant frame is made use of if required, that is, if the preceding packet is lost.

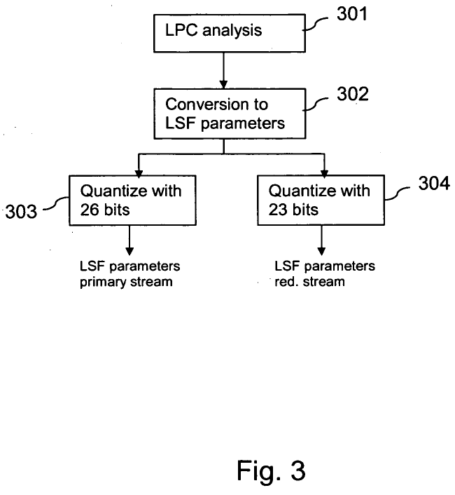

Exemplary operations in the modified AMR encoding component 22 will now be described with reference to FIGS. 3 to 5.

The AMR encoding component 22 is to use a 7.4 kbit/s AMR mode primary encoding resulting in a primary frame and a 4.75 kbit/s AMR mode redundancy encoding resulting in a redundant frame. As described in the above cited technical specification TS 26.090, quantized line spectral frequency (LSF) parameters, adaptive codebook parameters, algebraic codebook parameters, encoded adaptive codebook gains and encoded algebraic codebook gains have to be provided for each encoded frame. LSF values are generated on a per-frame basis, while the other parameters are generated on a per-subframe basis, each frame comprising four subframes. For the details of the encoding and the interactions between the codebook operations and the linear prediction (LP) filtering as a basis for obtaining the LSF parameters, it is referred the technical specification.

LPC Model

Both AMR modes use a predictive 10^{th} order Linear Prediction Coding (LPC) model, which is quantized as LSFs using a predictive split codebook. In 7.4 kbit/s mode the quantization uses 26 bits, whereas in 4.75 the LSF vector is quantized using 23 bits.

As presented in FIG. 3, an LP synthesis filter is computed for each speech frame in an LPC analysis, resulting in a vector of LPC coefficients (step 301), which is then converted into a more robust LSF vector (step 302). The LSF parameters belonging to each LSF vector are then quantized in a conventional manner with 26 bits for the primary frame using a lookup in a first codebook table to find the codebook index for the 7.4 kbit/s mode (step 303). In addition, the same LSF parameters are quantized in a conventional manner with 23 bits for the redundant frame using a lookup in a second codebook table to find the codebook index for the 4.75 kbit/s mode (step 304).

Compared to a full encoding as illustrated in FIG. 1, computation savings are achieved, since there is no need to calculate the LSF parameters twice. Only an additional table lookup is needed to a find codebook index for the 4.75 kbit/s mode.

Adaptive Codebook

In both AMR modes, the adaptive codebook uses a ⅓ resolution with pitch lags in the range [19⅓, 84⅔], and an integer resolution in the range [85, 143].

In the 7.4 kbit/s mode, the pitch lag is transmitted using the full range [19, 143] in the 1^{st} and the 3^{rd} subframe. The 2^{nd} and the 4^{th} subframe uses a ⅓ resolution in the range [T₁−5⅔, T₁₊4⅔], where T₁ is the pitch lag computed for the previous subframe. In the 4.75 kbit/s mode only the 1^{st} subframe uses the full range of pitch lag, while the other subframes use an integer pitch lag value in the range [T₁−5, T₁+4] plus a ⅓ resolution in the range [T₁−1⅔, T₁+⅔].

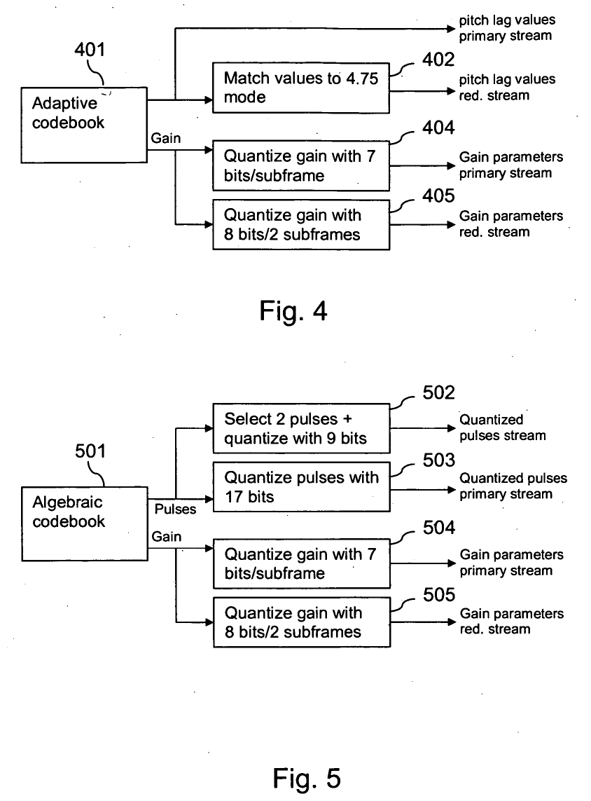

As presented in FIG. 4, the pitch lag values are computed in a conventional adaptive codebook coding for the 7.4 kbit/s mode (step 401). The resulting values are then used in addition as “input” values for finding the best match for the 4.75 kbit/s mode quantization (step 402). This can be achieved for example by mapping the 7.4 kbit/s mode codebook values to corresponding 4.75 kbit/s mode codebook values using a new mapping table.

From a computational point of view, the pitch lag search is the heaviest operation of the encoding. In the presented embodiment, there is no need to perform a pitch search at all for the redundant frame.

Algebraic Codebook

The difference between the algebraic codebook coding for the 7.4 kbit/s mode and the algebraic codebook coding for the 4.75 kbit/s mode constitutes the main difference between both AMR modes. Moreover, the pulse search for this codebook is also the major contributor to the overall encoder complexity. In the 7.4 kbit/s mode, 4 non-zero pulses are determined per subframe, which are encoded with 17 bits per subframe, whereas in the 4.75 kbit/s mode, only 2 pulses are determined per subframe, which are encoded with 9 bits per subframe.

As presented in FIG. 5, 4 non-zero pulses per subframe may be searched in a conventional manner for the 7.4 kbit/s mode (step 501) and encoded with 17 bits per subframe using the algebraic codebook for the 7.4 kbit/s mode (step 502). In addition, the two most important pulses per subframe are selected from among the found 4 non-zero pulses using additional information which is available in the AMR encoding component 22. The selected pulses are then quantized with 9 bits per subframe using the algebraic codebook for the 4.75 kbit/s mode. (step 503)

This approach thus avoids extensive search loops for the 4.75 kbit/s mode and reduces the computational complexity significantly.

Adaptive Codebook and Algebraic Codebook Gains

In the 7.4 kbit/s mode, the adaptive and the algebraic codebook gains for each subframe are vector quantized with 7 bits per subframe. In the 4.75 kbit/s mode, in contrast, the respective codebook gains for the 1^{st} and the 2^{nd} subframe are vector quantized together using 8 bits, and also the respective codebook gains for the 3^{rd} and the 4^{th} subframe are vector quantized together using 8 bits.

As presented in FIG. 4 for the adaptive codebook and in FIG. 5 for the algebraic codebook, the gain values are determined (step 401, 501) and encoded (step 404, 504) on the one hand in a conventional manner for the 7.4 kbit/s mode. In addition, the already determined gain values are encoded in accordance with the 4.75 kbit/s mode gain quantization scheme (step 405, 505). Thus, the adaptive and the algebraic codebook gains do not have to be determined separately for the 4.75 kbit/s mode.

All parameters determined in accordance with the 7.4 kbit/s mode are then used for forming the primary frame, while all parameters determined in accordance with the 4.75 kbit/s mode are used for forming the redundant frame. Primary frames and redundant frames are then assembled to RTP packets as mentioned above.

Summarized, the generation of LSF vectors, the pitch lag search, the search loops for finding pulse positions and the determination of gain values do not have to be carried out separately for the primary frame and the redundant frame. Thereby, the computation load is reduced significantly compared to the approach presented with reference to FIG. 1. In addition, a state mismatch at the decoder 28 is prevented, as the same state-machine is used for generating the parameters for both AMR modes.

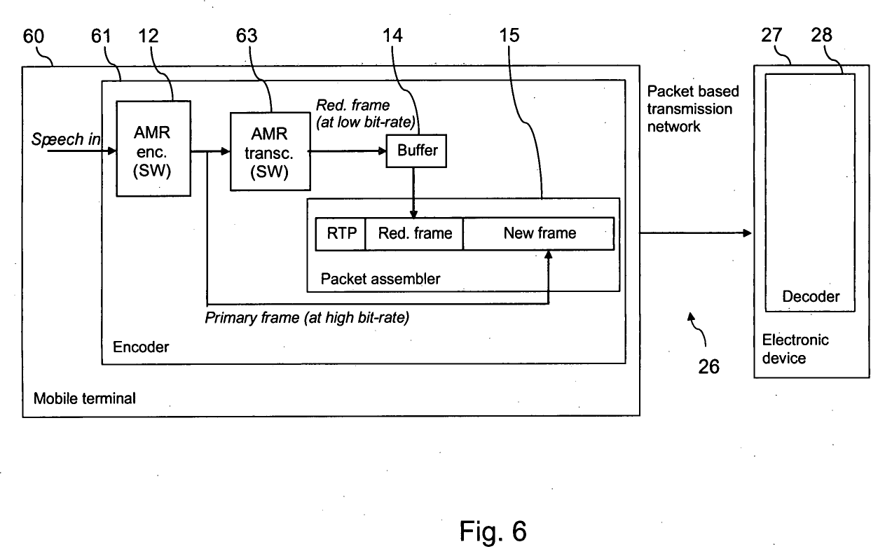

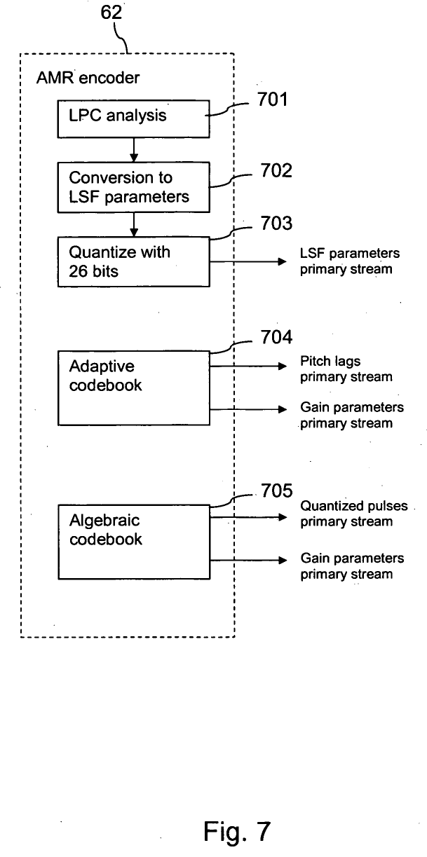

FIG. 6 is a schematic block diagram of a packet based transmission system, which uses an efficient redundancy coding in accordance with a second embodiment of the invention.

The transmission system comprises again by way of example a mobile terminal 60, a packet based transmission network 26, like an IP network, and a further electronic device 27.

The mobile terminal 60 is a conventional mobile terminal which comprises an AMR based speech encoder 61 modified in accordance with the invention.

The speech encoder 61 comprises a conventional AMR encoding component 12. The output of the AMR encoding component 12 is connected on the one hand directly to a packet assembler 15. The output of the AMR encoding component 12 is connected on the other hand via a parameter level AMR transcoder 63 and a buffer 14 to the packet assembler 15.

The other electronic device 27 comprises again a conventional AMR base speech decoder 28.

The AMR encoding component 12 receives a speech frame and produces from that an encoded primary frame at a selected primary bit rate as known in the art, for example like the AMR encoding component 12 of the AMR based speech encoder of FIG. 1.

The primary frame is provided to the packet assembler 15 and to the AMR transcoder 63. The AMR transcoder 63 transcodes the encoded parameters in the primary frame in order to obtain encoded parameters for a redundant frame. The redundant frame is then provided to the buffer 14. The buffer 14 buffers the redundant frame for the duration of one frame and forwards it then to the packet assembler 15.

The packet assembler 15 assembles a respective RTP packet in a conventional manner by combining an RTP header with an old redundant frame obtained from the buffer 14 and a new primary frame obtained directly from the AMR encoding component 12.

The assembled RTP packet is then transmitted by the mobile terminal 60 via the packet based transmission network 26 to the other electronic device 27. In the other electronic device 27, the received packets are processed by the AMR based speech decoder 28 in a conventional manner.

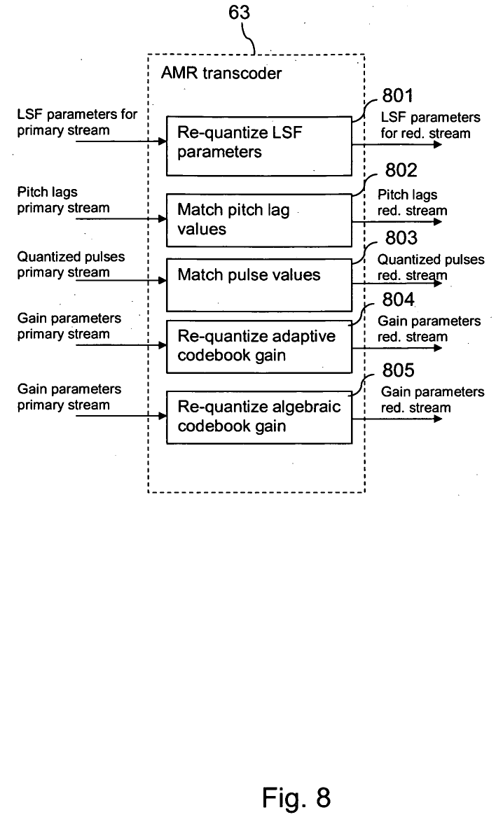

Exemplary operations in the modified AMR based speech encoder 61 will now be described in more detail with reference to FIGS. 7 and 8. FIG. 7 is a diagram illustrating the operation in the AMR encoding component 12, while FIG. 8 is a diagram illustrating the operation in the AMR transcoder 63.

By way of example, a 7.4 kbit/s AMR mode encoding is to be used again for generating a primary frame and a 4.75 kbit/s AMR mode encoding is to be used again for generating a redundant frame. As described in the above cited technical specification TS 26.090, quantized LSF parameters, adaptive codebook parameters, algebraic codebook parameters, encoded adaptive codebook gains and encoded algebraic codebook gains have to be provided for each encoded frame. The requirements on these parameters are the same as described above for the first embodiment.

In contrast to the first embodiment, however, in this embodiment the entire primary frame is first generated according to the 7.4 kbit/s mode and output by the conventional AMR encoding component 12. As illustrated in FIG. 7, the LPC coefficient vector resulting in an LP analysis (step 701) is converted into an LSF vector (step 702) and the corresponding LSF parameters are quantized using 26 bits (step 703). The adaptive codebook encoding results in coded pitch lag values and in gain values encoded with 7 bits per subframe (step 704). The algebraic codebook encoding results in four pulses per subframe, which are encoded with 17 bits, and in gain values encoded with 8 bits for two subframes (step 705). All these parameters are comprised in the primary frame output by the AMR encoding component 12.

As illustrated in FIG. 8, the 7.4 kbit/s mode LSF parameters in the primary frame are re-quantized in the parameter level AMR transcoder 63 to obtain quantized LSF parameters corresponding to the codebook configuration used in the 4.75 mode (step 801). The re-quantization can be achieved for example by means of a table mapping 7.4 kbit/s mode codebook indices to corresponding 4.75 kbit/s mode codebook indices.

The encoded pitch lag values in the primary frame are used in the parameter level AMR transcoder 63 for finding a best match according to the 4.75 kbit/s mode pitch lag quantization (step 802).

The encoded pulses in the primary frame are used in the parameter level AMR transcoder 63 for selecting two suitable ones and for quantizing the selected ones according to the algebraic codebook usage for the 4.75 kbit/s mode (step 803).

Finally, the encoded gain values for the adaptive codebook are mapped to a matching value in the 4.75 mode gain quantization scheme (step 804). Equally, the encoded gain values for the algebraic codebook are mapped to a matching value in the 4.75 mode gain quantization scheme (step 805).

The parameters determined in accordance with the 4.75 kbit/s mode are then used for forming the redundant frame, which is forwarded to the buffer 14 as mentioned above.

It becomes apparent that also in this embodiment, the generation of LSF vectors, the pitch lag search, the search loops for finding pulse positions and the determination of gain values does not have to be carried out separately for the primary frame and the redundant frame. Thus, a considerable computation load is saved in this embodiment as well. In addition, a state mismatch at the decoder is also prevented. Further, a conventional single AMR encoding component can be employed, and only a new AMR transcoder has to be added. In the first embodiment, in contrast, the computational load may be even lower as a transcoding is largely not required.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for enabling a compensation of packet losses in a packet based transmission of data frames, wherein packets provided for transmission include a first type of frames corresponding to a respective data frame encoded using a first bit rate coding mode and a second type of frames corresponding to a respective data frame encoded using a second bit rate coding mode, said method comprising:
extracting parameters from a data frame which is transmitted in accordance with said first bit rate coding mode;
quantizing said extracted parameters in accordance with said first bit rate coding mode to obtain quantized parameters forming a frame of said first type; and
generating a frame of said second type based on at least one of said parameters extracted for said frame of said first type and said quantized parameters of said frame of said first type.

2. The method according to claim 1, wherein generating a frame of said second type based on said parameters extracted for said frame of said first type comprises quantizing at least a part of said extracted parameters in accordance with said second bit rate coding mode to obtain at least a part of quantized parameters for said frame of said second type.

3. The method according to claim 1, wherein generating a frame of said second type based on said quantized parameters of said frame of said first type comprises transcoding at least a part of said quantized parameters of said frame of said first type to obtain at least a part of quantized parameters of said frame of said second type.

4. The method according to claim 3, wherein transcoding at least part of said quantized parameters of said frame of said first type comprises at least one of re-quantizing said quantized parameters of said frame of said first type to obtain quantized parameters for said frame of said second type in accordance with said second bit rate coding mode and mapping said quantized parameters of said frame of said first type to quantized parameters for said frame of said first type in accordance with said second bit rate coding mode.

5. The method according to claim 1, wherein a frame of said first type is a primary frame corresponding to a respective current data frame, wherein the primary frame is encoded using a higher bit rate coding mode, and wherein a frame of said second type is a redundant frame corresponding to a respective previous data frame, which is encoded using a lower bit rate coding mode.

6. The method according to claim 1, wherein said data is speech data.

7. The method according to claim 1, wherein said first bit rate coding mode and second bit rate coding mode are different adaptive multirate coding modes.

8. The method according to claim 1, wherein said extracted parameters comprise at least one of, line spectral frequency parameters, pitch lag values, pitch gains, pulse positions and pulse gains.

9. The method according to claim 1, wherein said extracted parameters result from at least one of a linear prediction coding, an adaptive codebook coding and an algebraic codebook coding.

10. An encoder for encoding data frames for a packet based transmission, which encoding enables a compensation of packet losses in a transmission, wherein packets provided for transmission include a first type of frames corresponding to a respective data frame encoded using a first bit rate coding mode and a second type of frames corresponding to a respective data frame encoded using a second bit rate coding mode, and wherein said encoder comprises an encoding portion,
the encoding portion is configured to extract parameters from a data frame which is transmitted in accordance with said first bit rate coding mode;
the encoding portion is configured to quantize extracted parameters in accordance with said first bit rate coding mode to obtain quantized parameters forming a frame of said first type; and
the encoding portion is configured to generate a frame of said second type based on at least one of parameters extracted for a frame of said first type and quantized parameters of a frame of said first type.

11. The encoder of claim 10, wherein said encoding portion comprises a dual-mode encoding component, and wherein for generating a frame of said second type based on parameters extracted for a frame of said first type comprises, said dual-mode encoding component is configured to quantize at least a part of said extracted parameters in accordance with said second bit rate coding mode to obtain at least a part of quantized parameters for said frame of said second type.

12. The encoder of claim 10, wherein said encoding portion comprises a single-mode encoding component for extracting parameters for a frame of said first type and for quantizing said extracted parameters for a frame of said first type, and wherein said encoding portion comprises a transcoder for generating a frame of said second type based on said quantized extracted parameters of a frame of said first type.

13. The encoder of claim 10, further comprising a buffer adapted to buffer generated frames of said second type, and further comprising a packet assembler adapted to assemble in a respective packet, a packet header, a frame of said first type provided by said encoding portion for a current data frame and a frame of said second type provided by said buffer for a previous data frame.

14. Electronic device, comprising an encoder according to claim 10.

15. Packet based transmission system, said system comprising: an encoder according to claim 10; a decoder adapted to decode data encoded by said encoder; and a packet based transmission network adapted to enable a transmission of encoded data between said encoder and said decoder.

16. A computer-readable medium comprising computer-readable code for enabling a compensation of packet losses in a packet based transmission of data frames, wherein packets provided for transmission include a first type of frames corresponding to a respective data frame encoded using a first bit rate coding mode and a second type of frames corresponding to a respective data frame encoded using a second bit rate coding mode, said computer readable code enables a procedure when running in a processing component of an electronic device the procedure comprising:
extracting parameters from a data frame which is to be transmitted in accordance with said first bit rate coding mode;
quantizing said extracted parameters in accordance with said first bit rate coding mode to obtain quantized parameters forming a frame of said first type; and
generating a frame of said second type based on at least one of said parameters extracted for said frame of said first type and said quantized parameters of said frame of said first type.

17. A software program product in which the computer-readable code according to claim 16, is stored.

18. An encoder for encoding data frames for a packet based transmission, which encoding enables a compensation of packet losses in a transmission, wherein packets provided for transmission include a first type of frames corresponding to a respective data frame encoded using a first bit rate coding mode and a second type of frames corresponding to a respective data frame encoding using a second bit rate coding mode, and wherein said encoder comprises an encoding portion, the encoding portion comprising:
an extraction means for extracting parameters from a data frame that is transmitted in accordance with said first bit rate coding mode;
a quantizing means for quantizing extracted parameters in accordance with said first bit rate coding mode to obtain quantized parameters forming a frame of said first type; and
a generating means for generating a frame of said second type based on at least one of parameters extracted for a frame of said first type and quantized parameters of a frame of said first type.
